(19) United States
(12) Patent Application Publication
(10) Pub. No.: US 2013/0140162 A1
(43) Pub. Date: Jun. 6, 2013

(54) Key Structure for Keyboards

(71) Applicant: TIANMIN LU, New Taipei City (TW)

(72) Inventor: TIANMIN LU, New Taipei City (TW)

(21) Appl. No.: 13/309,568

(22) Filed: Dec. 2, 2011

(51) Int. Cl. H01H 13/02

(52) U.S. Cl. 200/344

(57) ABSTRACT

An improved key structure, for keyboards, comprises a keycap and a scissor-like assembly disposed above a bottom plate. A membrane sheet containing an electrical circuit is placed on the bottom plate and is provided with a silicone elastomer at a center thereof. A middle plastic plate has first engagement portions and second engagement portions and is placed on the membrane sheet. The scissor-like assembly has engagement members and is pivotally mounted to the first engagement portions and the second engagement portions of the middle plastic plate. The keycap is mounted on the scissor-like assembly. The engagement portions of the middle plastic plate and the engagement members of the scissor-like assembly are configured symmetrically, so that the scissor-like assembly can be pivotally mounted to the middle plastic plate in a direction, being horizontally reversed to its original direction, so as to simplify the operation of assembling parts of the key structure.

### TECHNICAL FIELD OF THE INVENTION

The present invention relates to an improved key structure for keyboards, and more particularly to a key structure, whereby the scissor-like assembly thereof can be pivotally mounted to the middle plastic plate and the keycap thereof in a direction, which is horizontally reversed to its original direction, so as to simplify the operation of assembling parts of the key structure.

### DESCRIPTION OF THE PRIOR ART

At present, a key structure for keyboards, especially for a thin type of keyboards, is mainly composed of a keycap, a support structure (or called a scissor-like structure), a signal actuating means, and a bottom plate, among which the scissor-like structure is a significant component for the function of the key structure, and the design of the scissor-like structure may affect the quality of the keyboards and the operation thereof.

A conventional key structure for keyboards, as shown in FIG. 1, generally comprises a scissor-like assembly 1, a middle plastic plate 17, and a keycap 18. The scissor-like assembly 1 includes an inner lever frame 13 and an outer lever frame 14, which are each provided with cylindrical pivot pins 11 and are pivotally coupled together by using cylindrical bosses 15, on the inner lever frame 13, to be inserted into holes 16, on the outer lever frame 14. The middle plastic plate 17 is provided with engagement portions 12 for pivotally mounted with the cylindrical pivot pins 11 of the scissor-like assembly 1. However, with such kind of scissor-like assembly, it is difficult for the inner lever frame 13 to be coupled with the outer lever frame 14, and the cylindrical pivot pins 11 to be mounted to the engagement portions 12 of the middle plastic plate 17. Thus, manual operation is required for those parts to be assembled properly, thereby increasing the manpower consumption. Besides, since the middle plastic plate 17 is not provided with a foolproof feature, in an assembling operation, when the middle plastic plate 17 is placed under an incorrect or reversed direction, and forced to be mounted to the scissor-like assembly 11, the middle plastic plate 17 is prone to be damaged, and thus the plate 17 should be replaced with a new one to continue the assembling operation, thereby increasing the operation time and cost.

In view of the foregoing problems, based on long-term experiences of related works, the applicant has contrived an improved key structure for keyboards, which can simplify the operation of assembling parts of keyboards.

### SUMMARY OF THE INVENTION

The primary object of the present invention is to provide an improved key structure for keyboards, wherein the engagement portions of the middle plastic plate and the engagement members of the scissor-like assembly are configured symmetrically, so that the scissor-like assembly can be pivotally mounted to the middle plastic plate in a direction, which is horizontally reversed to its original direction, so as to simplify the operation of assembling parts of the key structure.

The secondary object of the present invention is to provide an improved key structure for keyboards, wherein the keycap has four engagement portions, which each has a hook being formed with a sliding recess and are configured symmetrically, so that the keycap can be pivotally mounted to the scissor-like assembly in a direction, which is horizontally reversed to its original direction, so as to simplify the operation of assembling parts of the key structure.

The improved key structure may comprise a keycap, a scissor-like assembly, a silicone elastomer, a middle plastic plate, a membrane sheet containing an electrical circuit therein, and a bottom plate. With the exchange of the positions of the first and second engagement members of the scissor-like assembly, the scissor-like assembly can be pivotally mounted to the middle plastic plate in a direction, which is horizontally reversed to its original direction (i.e., the direction of the scissor-like assembly is 180 degrees from the original direction of the scissor-like assembly) as well, so as to simplify the operation of assembling parts of the key structure. The keycap is formed with third engagement portions and fourth engagement portions, which may vertically correspond to the third engagement members and the fourth engagement members of the scissor-like assembly, and are configured symmetrically, so that the keycap can be pivotally mounted to the scissor-like assembly in a direction, which is horizontally reversed to its original direction (i.e., the direction of the keycap is 180 degrees from the original direction of the keycap), so as to simplify the operation of assembling parts of the key structure. Since the engagement portions of the middle plastic plate and the keycap, and the engagement members of the scissor-like assembly are configured symmetrically, in an assembling operation, even though the direction of the scissor-like assembly or the keycap is reversed, those parts can be assembled properly as well. Thus, the problems of mistaking the direction of those parts and causing their damages, as in conventional keyboards, can be prevented. Furthermore, the design of the present invention can simplify the operation of assembling parts of the key structure, and this may facilitate an introduction of automatic assembling operation at a later stage.

Other objects, advantages, and novel features of the present invention will become more apparent from the following detailed description when taken in conjunction with the accompanying drawings.

### BRIEF DESCRIPTION OF THE DRAWINGS

FIG. 1 is an exploded view of a key structure of prior art.

FIG. 2 is an exploded view of a key structure of the present invention.

FIG. 3 is an exploded view of the key structure of the present invention.

FIG. 4 is an exploded view of the key structure of the present invention.

FIG. 5 is a 3-dimensional view of a scissor-like assembly of the key structure of the present invention.

FIG. 6 is an exploded view of the scissor-like assembly of the key structure of the present invention.

FIG. 7 is a plan view of the key structure of the present invention, which schematically shows a condition of the key structure, in which the scissor-like assembly thereof is assembled in its original direction.

FIG. 7A is a sectional view of the key structure of the present invention, which is taken along the A-A line in FIG. 7.

FIG. 8 is a plan view of the key structure of the present invention, which schematically shows another condition of the key structure, in which the scissor-like assembly thereof is assembled in a direction, which is horizontally reversed to its original direction.

FIG. 8A is a sectional view of the key structure, which is taken along the A-A line in FIG. 8.

FIG. 9 is a side view of the key structure of the present invention, which schematically shows a condition of the key structure, in which the scissor-like assembly thereof is assembled in its original direction.

FIG. 9A is a side view of the key structure of the present invention, which schematically shows another condition of the key structure, in which the scissor-like assembly thereof is assembled in a direction, which is horizontally reversed to its original direction.

FIG. 10 is a plan view of a keycap of the key structure of the present invention.

FIG. 10A is a sectional view of the keycap of the key structure, which is taken along the A-A line in FIG. 10.

FIG. 10B is an enlarged fragmentary view of an engagement portion of the keycap in FIG. 10A.

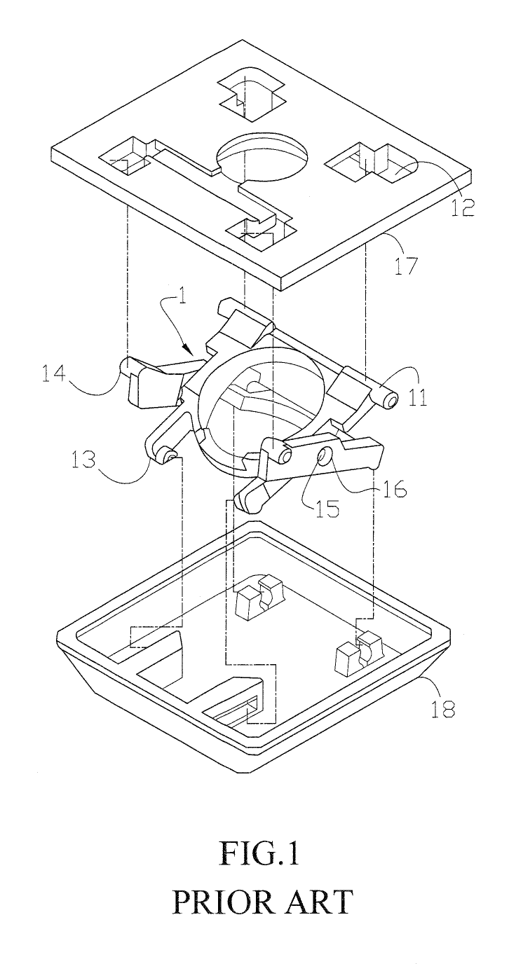

### DETAILED DESCRIPTION OF THE PREFERRED EMBODIMENTS

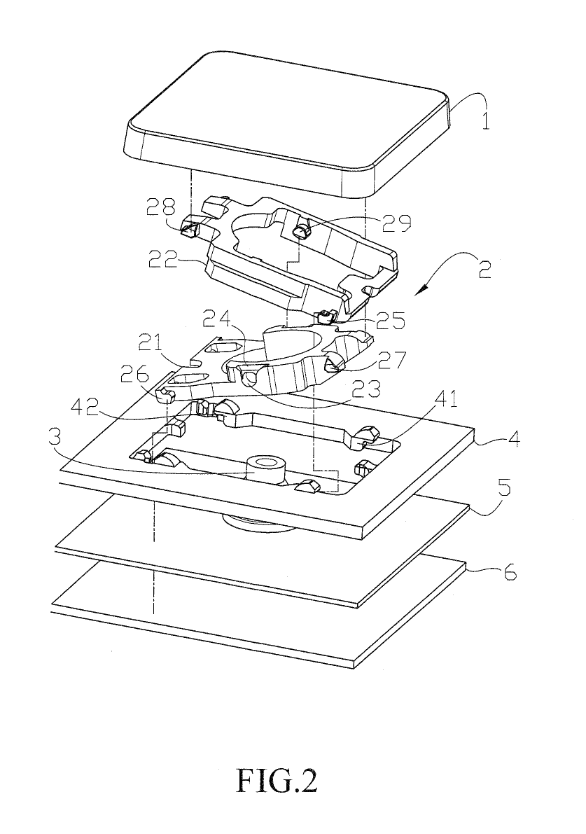

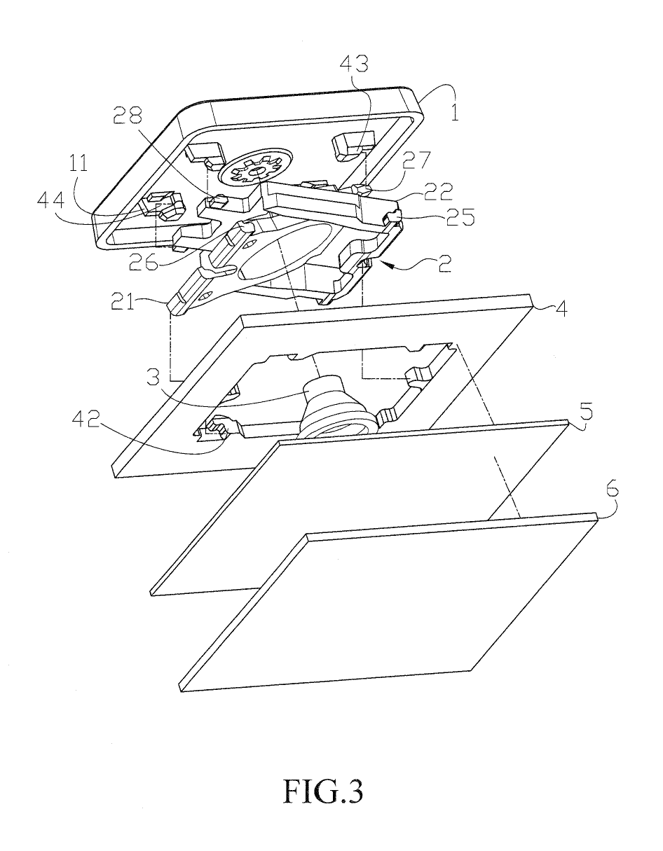

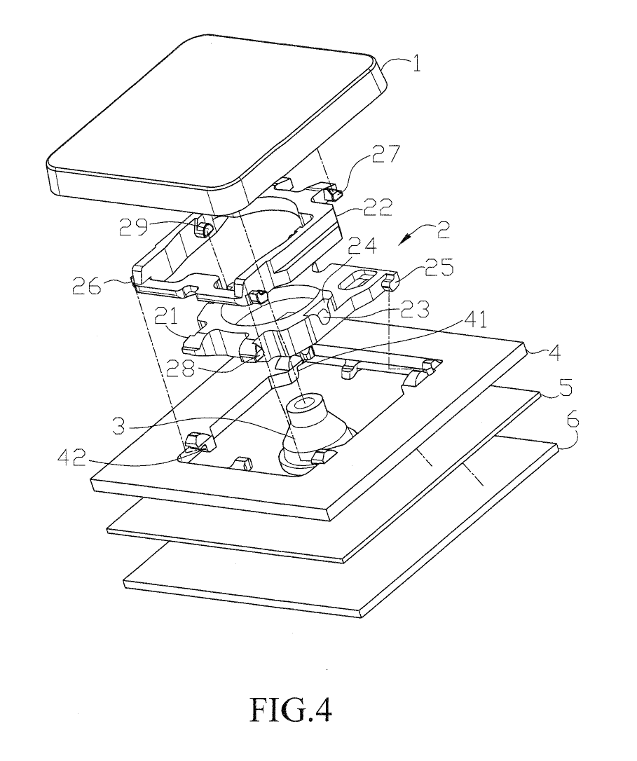

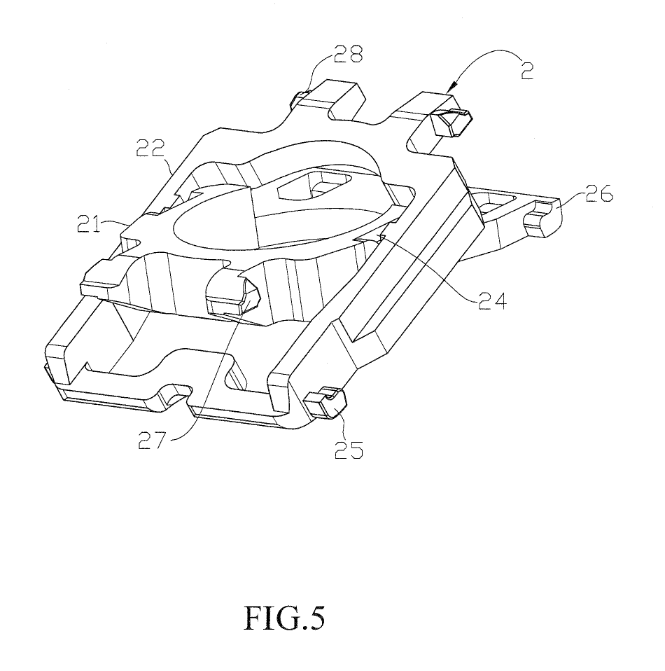

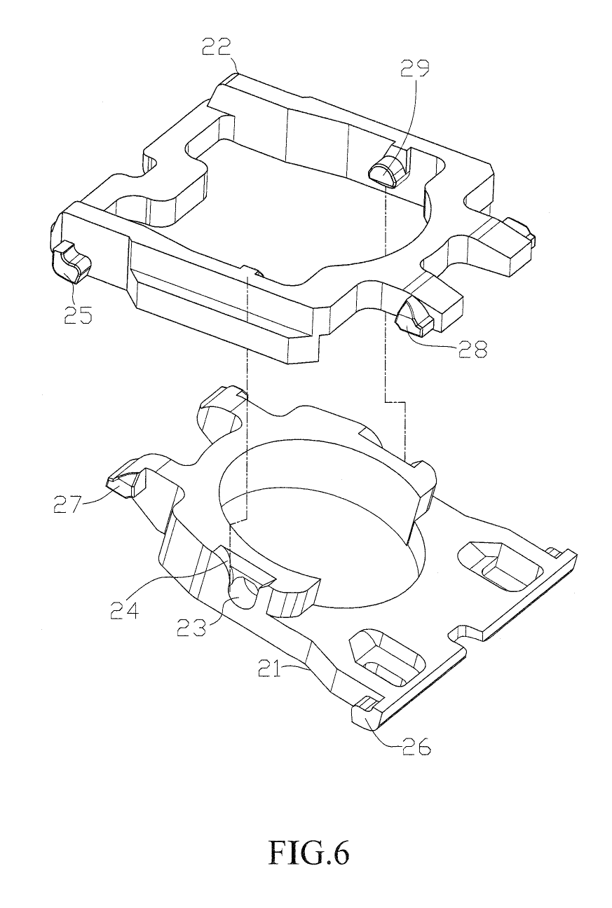

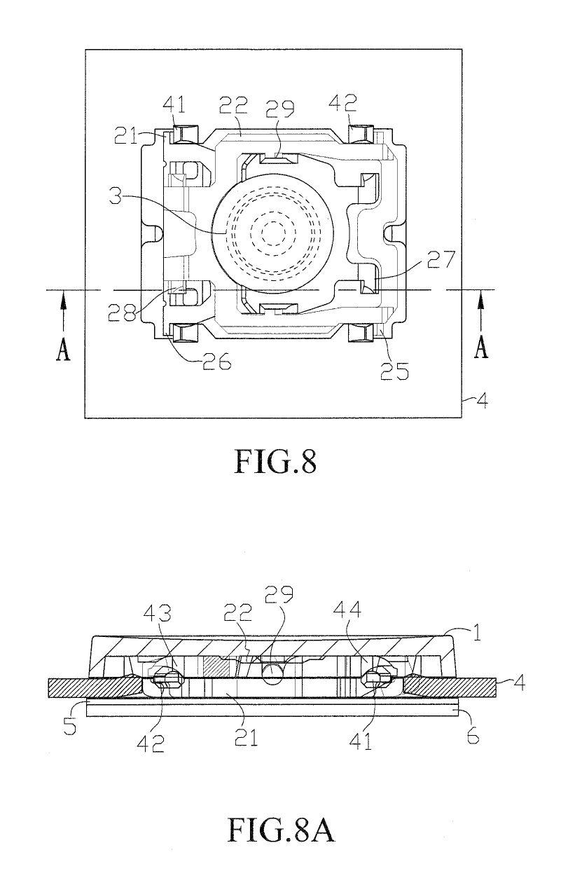

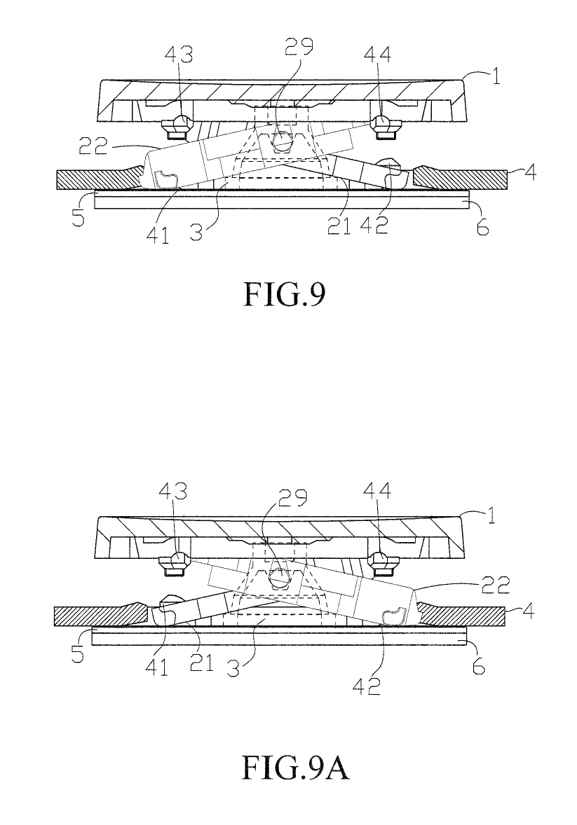

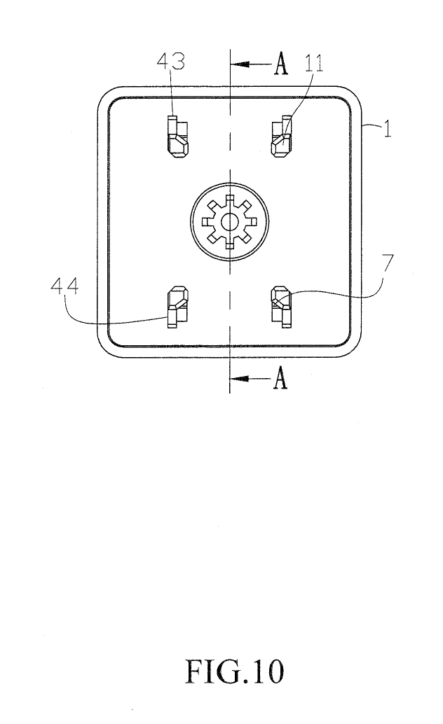

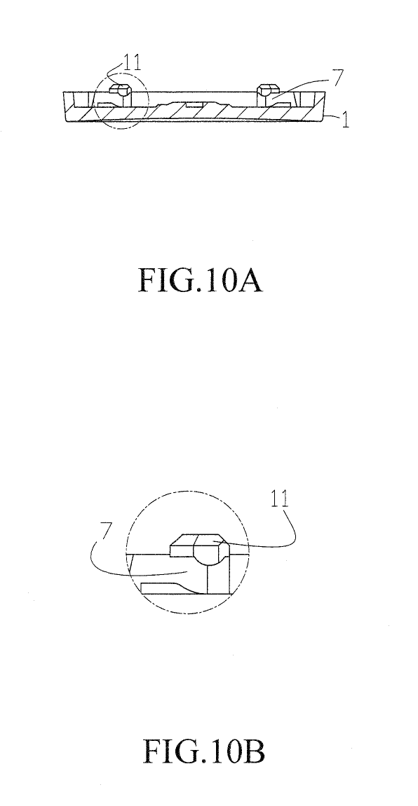

The following description will illustrate a preferred embodiment of a key structure for keyboards according to the present invention, with reference to FIGS. 2-10. As shown, the key structure generally comprises a keycap 1, a scissor-like assembly 2, silicone elastomer 3, a middle plastic plate 4, a membrane sheet 5 containing an electrical circuit therein, and a bottom plate 6.

As shown in FIGS. 2-10, the keycap 1 and the scissor-like assembly 2 are disposed above the bottom plate 6. The membrane sheet 5 is placed on the bottom plate 6, and is provided with the silicone elastomer 3 at a center thereof The middle plastic plate 4, which is formed with first engagement portions 41 and second engagement portions 42, is placed on the membrane sheet 5. The scissor-like assembly 2 is pivotally mounted to the first engagement portion 41 and the second engagement portion 42 of the middle plastic plate 4. The keycap 1, which is formed with third engagement portions 43 and fourth engagement portions 44, is mounted on the scissor-like assembly 2.

As shown in FIGS. 2-10, the silicone elastomer 3 is provided at the center of the membrane sheet 5. The middle plastic plate 4 defines a rectangular opening at a center thereof and is formed with the first engagement portions 41 and the second engagement portions 42 at a periphery thereof which are symmetrically configured to cooperate with the scissor-like assembly 2, so that the scissor-like assembly 2 can be mounted to the middle plastic plate 4 in a direction, which is reversed to its original direction, as will be fully described later. Also, the middle plastic plate 4 is placed on the membrane sheet 5, and the silicone elastomer 3 extends through the rectangular opening of the middle plastic plate 4. The scissor-like assembly 2 includes an inner lever frame 21 and an outer lever frame 22, wherein the outer lever frame 22 is formed with two bosses 29 respectively at two opposing inner side thereof, whereas the inner frame 21 is defined with two holes 23, corresponding to the two bosses 29, respectively at two opposing outer side thereof. Also, there are two introductory recesses 24 respectively defined over the two holes 23 to facilitate the bosses 29 to be pivotally coupled to the two holes 23, so that the inner lever frame 21 and the outer lever frame 22 can be pivotally coupled together to form a pivot axis, for serving as a support structure for a key. The inner lever frame 21 has two second engagement members 26 at a lower portion thereof and two third engagement members 27 at an upper portion thereof, wherein each of the second engagement members 26 is configured as a substantially L-shaped member to correspond to one of the second engagement portions 42 of the middle plastic plate 4. The outer frame 22 has two first engagement members 25 at a lower portion thereof and two fourth engagement members 28 at an upper portion thereof, wherein each of the first engagement members 25 is configured as a substantially L-shaped member to correspond to one of the first engagement portions 41 of the middle plastic plate 4. The third engagement members 27 and the fourth engagement members 28 are configured to correspond to the third engagement portions 43 and the fourth engagement portions 44 of the keycap 1 respectively, wherein each of the third and fourth engagement portions 43, 44 is formed with a hook 11.

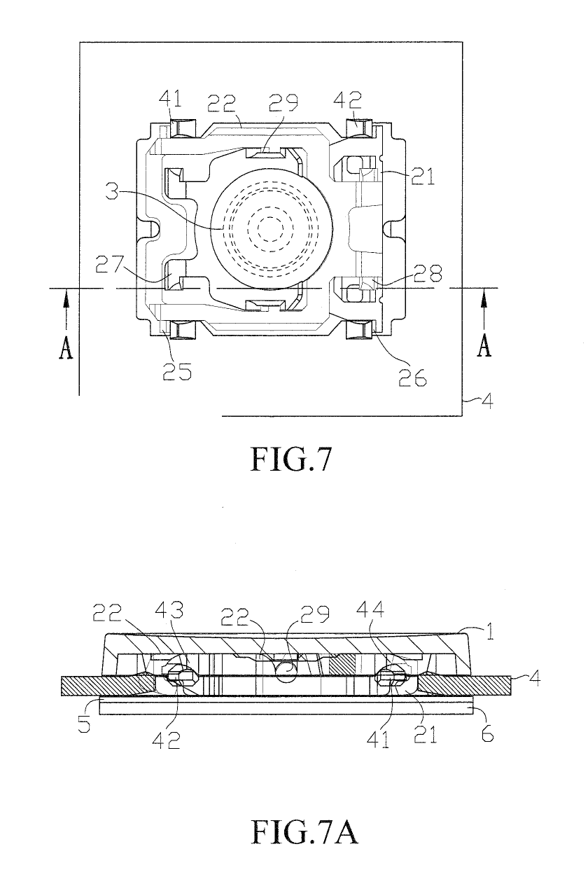

As shown in FIGS. 7-9, the middle plastic plate 4 is placed above the membrane sheet 5 and the bottom plate 6, wherein the bottom plate 6 can be made of rigid and durable material, such as iron, aluminum, stainless steel, plastic, and so on. The first engagement members 25 and the second engagement members 26 are configured symmetrically with respect to the pivoting axis of the scissor-like assembly 2. The third engagement members 27 and the fourth engagement member 28 are configured symmetrically with respect to the pivoting axis of the scissor-like assembly 2. The first engagement portions 41 and the second engagement portions 42 of the middle plastic plate 4 are configured symmetrically. The third engagement portions 43 and the fourth engagement portions 44 of the keycap 1 are configured symmetrically, wherein each hook 11 of the engagement portions 43, 44 is formed with a sliding recess 7 being symmetrical with each other. Thus, in the operation of assembling parts of keyboards, the positions of the first engagement members 25 and the second engagement members 26 can be exchanged to complete a proper assembling as well. Thus, the first engagement members 25 and the second engagement members 26 of the scissor-like assembly 2 can be mounted to the first engagement portions 41 and the second engagement portions 42 of the middle plastic plate 4 properly, irrespectively of the exchange of the positions of the engagement members 25, 26. It is apparent that the scissor-like assembly 2 can be pivotally mounted to the middle plastic plate 4 in a direction, which is horizontally reversed to its original direction (i.e., the direction of the scissor-like assembly is 180 degrees from the original direction of the scissor-like assembly), so that the operation of assembling parts of the key structure can be simplified. Also, the third engagement members 27 and the fourth engagement members 28 can be mounted to the third engagement portions 43 and the fourth engagement portions 44 of the keycap 1 properly, irrespectively of the exchange of the positions of the engagement members 28, 27, which is resulted from the exchange of the positions of the engagement members 25, 26. It is apparent that the keycap 1 can be pivotally mounted to the scissor-like assembly 2 in a direction, which is horizontally reversed to its original direction (i.e., the direction of the keycap is 180 degrees from the original direction of the keycap), so that the operation of assembling parts of the key structure can be simplified.

As mentioned above, the first engagement members 25 and the second engagement members 26 are each configured to be a substantially L-shaped member, which contains a curved surface. This feature can facilitate the first and second members 25, 26 to be mounted to the first and second engagement portions 41, 42, while in an automatic assembling operation. The first engagement portions 41 of the middle plastic plate 4 is configured to be symmetrical with the second engagement portions 42 of the middle plastic plate 4; the third engagement portions 43 of the keycap 1 is configured to be symmetrical with the fourth engagement portions 44 of the keycap 1, wherein each hook 11 of the engagement portions 43, 44 is formed with a sliding recess 7 being symmetrical with each other; the first engagement members 25 of the scissor-like assembly 2 is configured to be symmetrical with the second engagement members 26 of the scissor-like assembly 2; the third engagement members 27 of the scissor-like assembly 2 is configured to be symmetrical with the fourth engagement members 28 of the scissor-like assembly 2. Accordingly, these features can optimize the automatic operation of assembling parts of keyboards, thereby increasing the production efficiency. Also, the problems of mistaking the direction of the scissor-like assembly of a key to cause damages of parts, as in conventional keyboards, can be prevented. Thereby, in an assembling operation, no matter the direction of the scissor-like assembly 2 is oriented, the scissor-like assembly 2 can be pivotally mounted to the middle plastic plate 4 and the keycap 1 properly, either in its original direction or the horizontally reversed direction, and thus the operation of assembling parts of keyboards can be simplified.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. An improved key structure for keyboards, which includes a keycap and a scissor-like assembly disposed above a bottom plate, wherein a membrane sheet containing an electrical circuit is placed on the bottom plate, and is provided with a silicone elastomer at a center thereof, a middle plastic plate has first engagement portions and second engagement portions and is placed on the membrane sheet, the scissor-like assembly has engagement members and is pivotally mounted to the first engagement portions and the second engagement portions of the middle plastic plate, and the keycap is mounted on the scissor-like assembly, wherein the improvement comprises:
the engagement portions of the middle plastic plate and the engagement members of the scissor-like assembly are configured symmetrically, so that the scissor-like assembly can be pivotally mounted to the middle plastic plate in a direction, which is horizontally reversed to its original direction, so as to simplify the operation of assembling parts of the key structure.

2. An improved key structure for keyboards as claimed in claim 1, wherein the keycap has four engagement portions, which each has a hook being formed with a sliding recess and are configured symmetrically, so that the keycap can be pivotally mounted to the scissor-like assembly in a direction, which is horizontally reversed to its original direction, so as to simplify the operation of assembling parts of the key structure.
